(19) United States
(12) Patent Application Publication
(10) Pub. No.: US 2019/0301395 A1
(43) Pub. Date: Oct. 3, 2019

(54) WELDED INTEGRAL FORGED STEEL PISTON AND MANUFACTURING PROCESS THEREOF

(71) Applicant: Bin Zhou Donghailong Piston CO,LTD, Binzhou (CN)

(72) Inventors: Weibin ZHANG, Binzhou (CN); Jianjun LIU, Binzhou (CN); Jinyu JI, Binzhou (CN)

(21) Appl. No.: 16/260,088

(22) Filed: Jan. 28, 2019

(30) Foreign Application Priority Data
Apr. 3, 2018 (CN) 201810291334.7

(51) Int. Cl. F02F 3/00; F02F 3/18; F02F 3/26

(52) U.S. Cl. CPC F02F 3/003; F02F 2003/0061; F02F 3/26; F02F 3/18

(57) ABSTRACT

Disclosed are a welded integral forged steel piston and a manufacturing process thereof. A piston head and a piston skirt are fixedly connected. A closed cooling oil cavity is formed between the piston head and the piston skirt. The cooling oil cavity is communicated with the outside through an oil inlet and an oil outlet. The bottom end of the piston head is concentrically provided with annular inner welding shoulder A and outer welding shoulder A. The top end of the piston skirt is concentrically provided with annular inner welding shoulder B and outer welding shoulder B which are respectively matched with the inner welding shoulder A and the outer welding shoulder A. The present invention provides a welded integral forged steel piston with reasonable structure, safety, reliability and high production efficiency, and a manufacturing process thereof.

### CROSS-REFERENCE TO RELATED APPLICATIONS

This application claims the benefit of priority from Chinese Patent Application No. CN 201810291334.7, filed on Apr. 3, 2018. The content of the aforementioned application, including any intervening amendments thereto, is incorporated herein by reference in its entirety.

### TECHNICAL FIELD

The present invention relates to the technical field of piston manufacture, and in particular to a welded integral forged steel piston and a manufacturing process thereof.

### BACKGROUND

A piston is the “heart” of an automobile engine, bears alternating mechanical load and thermal load, and is one of key components with the worst working conditions in the engine. The piston has the functions of bearing gas pressure and transmitting the gas pressure to a connecting rod through a piston pin shaft to rotate a crankshaft. Failure of the piston will result in loss of power for the engine, and even scrap of the entire engine.

In recent decades, engine design and manufacturing technologies have been rapidly improved, especially for diesel engines which are developing towards high power and high load. The degree of intensification is constantly improved, and the explosive force has exceeded 20 MPa. At the same time, the emission requirements are becoming more and more stringent. Aluminum material has been gradually unable to meet the emission requirements of high power and high intensity for the engine. Thus, at present, many companies select steel material to replace aluminum alloy material, and especially the development of forged piston material represents the current development direction of the piston. Now there are two main types of steel pistons: a hinged pendulum type and an integral forged steel type. The hinged swing structure is: a piston head is forged steel, a piston skirt is aluminum, and the piston head and the piston skirt are processed separately and then connected through a piston pin. It is difficult for this piston to form a closed cooling oil cavity and the piston cooling effect is poor. At the same time, because a longer piston pin is required for connection, the overall weight is increased. Now, this piston is phased out in some developed countries. For the integral forged steel piston, generally, after forged and rough-machined, the head and the skirt are combined through some way to form a whole.

Chinese patent CN 1610601A discloses a method for manufacturing a forged steel piston. In this method, the head and the skirt are forged respectively; an inner cooling oil cavity is formed by friction welding after the head and the skirt are processed respectively; and two end welds of the head and the skirt are welded in one time. The welding area is large, and the piston with large cylinder diameter cannot be normally welded due to the influence of device precision and capacity. In addition, high-power friction welding requires a lot of power consumption, which wastes the energy.

Chinese patent CN 102407431 B discloses a manufacturing process of an integral hot-spinning pressed forged steel piston with an inner cooling oil cavity. In this method, the cooling oil cavity is closed by hot-spinning pressing after the inner part and the occlusion part of an oil passage are processed by integral blanks. This process requires the blanks as a whole structure, and the forging process is complex. Because the wall thickness of piston blanks is thick, the hot-spinning pressing efficiency is low. In the hot-spinning pressing process, the invention involves the need for a spinning chuck. Because the inner cooling oil passage is closed, the working mode and withdrawing mode of the spinning chuck are not described. In addition, due to the plastic deformation of material in the hot-spinning pressing process, the oil passage needs to be closed or to have a small gap, and the processing accuracy of the occlusion part of the oil passage needs to be higher.

Therefore, how to provide a welded integral forged steel piston with reasonable structure, safety, reliability and high production efficiency, and a manufacturing process thereof is an urgent problem for those skilled in the art.

### SUMMARY

In view of this, the present invention provides a welded integral forged steel piston and a manufacturing process thereof. On one hand, a piston head blank and a piston skirt blank are forged separately, thereby simplifying the forging technology, reducing requirements for device tonnage and reducing investment of device cost. On the other hand, the piston head and the piston skirt are processed separately, which also reduces the requirements for devices and cutters. Meanwhile, only one inner weld of two welds of the piston head and the piston skirt is welded by friction welding, thereby reducing the requirements for the power of a friction welding machine. Thus, a piston with large cylinder diameter can be welded with a friction welding machine with low power, thereby reducing device investment and expanding the use range of the devices. The periphery of the piston head and the periphery of the piston skirt are welded by electron beam welding or argon arc welding to form auxiliary welds, so as to strengthen welding reliability.

The present invention provides a welded integral forged steel piston, comprising a piston head and a piston skirt which are forged, wherein the piston head and the piston skirt are fixedly connected; a closed cooling oil cavity is formed between the piston head and the piston skirt; and the cooling oil cavity is communicated with the outside through an oil inlet and an oil outlet. The bottom end of the piston head is concentrically provided with annular inner welding shoulder A and outer welding shoulder A. The top end of the piston skirt is concentrically provided with annular inner welding shoulder B and outer welding shoulder B which are respectively matched with the inner welding shoulder A and the outer welding shoulder A. The inner welding shoulder A and the inner welding shoulder B are welded through friction welding to form a main weld. The outer welding shoulder A and the outer welding shoulder B are welded through melting welding to form an auxiliary weld.

Preferably, in the above welded integral forged steel piston, the piston head and the piston skirt are forged by quenched and tempered steel or non-quenched and tempered steel; and the quenched and tempered steel is selected from 42CrMo, and the non-quenched and tempered steel is selected from 38MnVS6.

Preferably, in the above welded integral forged steel piston, the oil inlet and the oil outlet are formed in the bottom of the cooling oil cavity on the piston skirt, so that a cooling medium in the cooling oil cavity can be in communication with a circulation cooling system of an engine so as to better cool the piston.

Preferably, in the above welded integral forged steel piston, the main weld is welded with a friction welding machine of 45 t. The friction welding machine of 45 t has largest upsetting force of 390 KN and largest welding area of 4100 mm², thereby reducing the requirements for the power of the friction welding machine. Thus, a piston with large cylinder diameter can be welded with a friction welding machine with low power, thereby reducing device investment and expanding the use range of the devices.

Preferably, in the above welded integral forged steel piston, the auxiliary weld comprises a top auxiliary weld and an excircle auxiliary weld. The top auxiliary weld is mainly used for strengthening the connecting quality between the piston head and the piston skirt. The excircle auxiliary weld plays the effect of supporting a piston ring.

Preferably, in the above welded integral forged steel piston, the top auxiliary weld is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth, thereby enhancing welding quality.

Preferably, in the above welded integral forged steel piston, the excircle auxiliary weld is welded by argon arc welding. Because the temperature at an excircle is low, the excircle auxiliary weld only plays the effect of supporting the piston ring. Requirements for the weld are low, and argon arc welding is selected, thereby reducing device investment and reducing the cost.

A manufacturing process of a welded integral forged steel piston comprises the following steps:

S1 material selection: selecting quenched and tempered steel or non-quenched and tempered steel bars with satisfactory diameter according to process requirements, and cutting and preparing the bars with a sawing machine;

S2 hot processing: determining heating time according to the process requirements, and heating the cut bars with an electromagnetic induction furnace to 1120-1250° C.;

S3 forging: conducting rough forging on the heated bars with a hydraulic press of 400 t; upsetting; removing oxide coatings on the surfaces of the bars; precision forging a piston head blank and a piston skirt blank after rough forging using an electric helical press of 1000 t; and determining precision forging number of times and the size of each precision forging pressure according to the process requirements to obtain the piston head blank and the piston skirt blank;

S4: rough machining: processing the top surface of the cooling oil cavity, the annular inner welding shoulder A and the annular outer welding shoulder A in the piston head blank; processing the bottom surface of the cooling oil cavity, the annular inner welding shoulder B and the annular outer welding shoulder B in the piston skirt blank to obtain a piston head semi-finished product and a piston skirt semi-finished product;

S5 welding: conducting friction welding on the piston head semi-finished product and the piston skirt semi-finished product after precision forging using a friction welding machine; welding the inner welding shoulder A and the inner welding shoulder B with a friction welding machine of 45 t to form a main weld, with the friction welding machine of 45 t having largest upsetting force of 390 KN and largest welding area of 4100 mm²; welding the outer welding shoulder A and the outer welding shoulder B through melting welding to form an auxiliary weld; the auxiliary weld comprising a top auxiliary weld and an excircle auxiliary weld, wherein the top auxiliary weld is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth; and

S6 post processing: conducting heat treatment, finish machining and surface treatment on the welded piston to finally obtain a piston finished product.

Preferably, in the above manufacturing process of the welded integral forged steel piston, in the heat treatment process, the piston forged by the quenched and tempered steel is firstly heated to 845-855° C., insulated for 2-3 hours, taken from a furnace and then oil-cooled; tempering temperature is 590-620° C. ; the piston is insulated for 3-4 hours; and finally, the piston is taken from the furnace and air-cooled. The piston forged by the non-quenched and tempered steel is only annealed to remove stress.

Preferably, in the above manufacturing process of the welded integral forged steel piston, in the finish machining: the piston after heat treatment is processed into a ring groove, a pin hole and an excircle profile of the piston; and in the surface treatment, the piston surface after finish machining is phosphorized and graphitized.

It is known from the above technical solution that, the present invention discloses a welded integral forged steel piston and a manufacturing process thereof. Firstly, a piston head blank and a piston skirt blank are forged separately, thereby simplifying the forging technology, reducing requirements for device tonnage and reducing investment of device cost.

Secondly, the piston head and the piston skirt are processed separately, which also reduces the requirements for devices and cutters and enables the processing to be simple and reasonable. Only one inner weld of two welds of the piston head and the piston skirt is welded by friction welding, thereby reducing the requirements for the power of a friction welding machine. Thus, a piston with large cylinder diameter can be welded with a friction welding machine with low power, thereby reducing device investment and expanding the use range of the devices.

Finally, the periphery of the piston head and the periphery of the piston skirt are welded by electron beam welding and argon arc welding to form auxiliary welds, so as to strengthen welding reliability. The oil inlet and the oil outlet are formed in the bottom of the cooling oil cavity on the piston skirt, so that a cooling medium in the cooling oil cavity can be in communication with a circulation cooling system of an engine so as to better cool the piston.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a front sectional view of a welded integral forged steel piston;

FIG. 2 is a side sectional view of a welded integral forged steel piston;

FIG. 3 is a bottom view of a welded integral forged steel piston;

FIG. 4 is a stereogram of a welded integral forged steel piston; and

FIG. 5 is a flow chart of a manufacturing process of a welded integral forged steel piston.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

Embodiments of the present invention disclose a welded integral forged steel piston and a manufacturing process thereof. On one hand, a piston head blank and a piston skirt blank are forged separately, thereby simplifying the forging technology, reducing requirements for device tonnage and reducing investment of device cost. On the other hand, the piston head and the piston skirt are processed separately, which also reduces the requirements for devices and cutters. Meanwhile, only one inner weld of two welds of the piston head and the piston skirt is welded by friction welding, thereby reducing the requirements for the power of a friction welding machine. Thus, a piston with large cylinder diameter can be welded with a friction welding machine with low power, thereby reducing device investment and expanding the use range of the devices. The periphery of the piston head and the periphery of the piston skirt are welded by electron beam welding or argon arc welding to form auxiliary welds, so as to strengthen welding reliability.

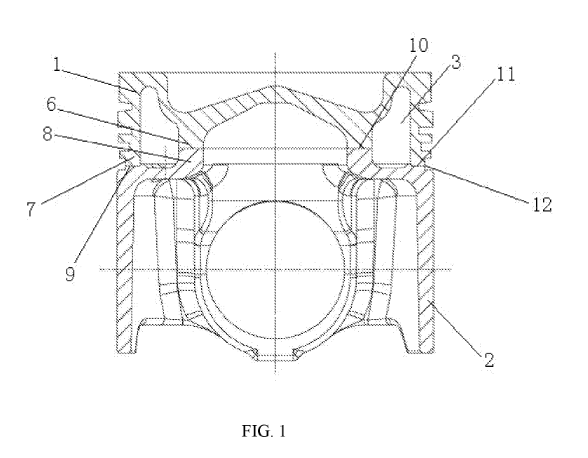

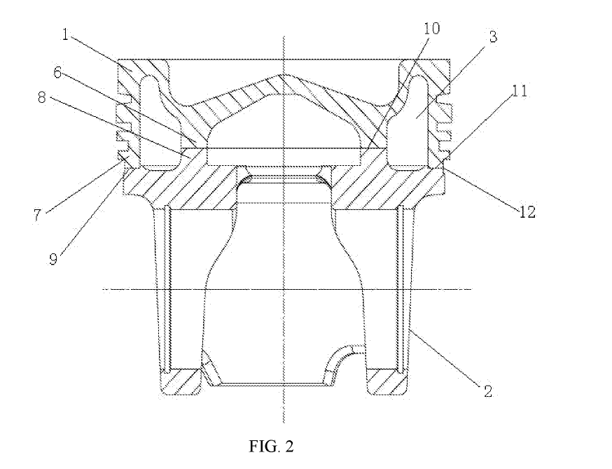

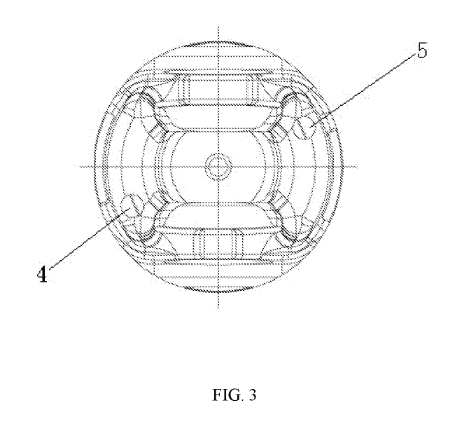

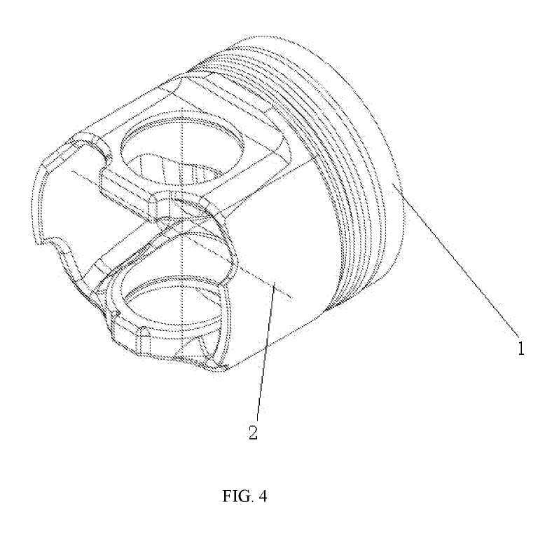

By combining with FIGS. 1-4, the present invention discloses a welded integral forged steel piston, comprising a piston head 1 and a piston skirt 2 which are forged, wherein the piston head 1 and the piston skirt 2 are fixedly connected; a closed cooling oil cavity 3 is formed between the piston head 1 and the piston skirt 2; and the cooling oil cavity 3 is communicated with the outside through an oil inlet 4 and an oil outlet 5. The bottom end of the piston head 1 is concentrically provided with annular inner welding shoulder A6 and outer welding shoulder A7. The top end of the piston skirt 2 is concentrically provided with annular inner welding shoulder B8 and outer welding shoulder B9 which are respectively matched with the inner welding shoulder A6 and the outer welding shoulder A7. The inner welding shoulder A6 and the inner welding shoulder B8 are welded through friction welding to form a main weld 10. The outer welding shoulder A7 and the outer welding shoulder B9 are welded through melting welding to form an auxiliary weld.

To further optimize the above technical solution, the piston head 1 and the piston skirt 2 are forged by quenched and tempered steel or non-quenched and tempered steel; and the quenched and tempered steel is selected from 42CrMo, and the non-quenched and tempered steel is selected from 38MnVS6.

To further optimize the above technical solution, the oil inlet 4 and the oil outlet 5 are formed in the bottom of the cooling oil cavity 3 on the piston skirt 2, so that a cooling medium in the cooling oil cavity 3 can be in communication with a circulation cooling system of an engine so as to better cool the piston.

To further optimize the above technical solution, the main weld 10 is welded with a friction welding machine of 45 t. The friction welding machine of 45 t has largest upsetting force of 390 KN and largest welding area of 4100 mm², thereby reducing the requirements for the power of the friction welding machine. Thus, a piston with large cylinder diameter can be welded with a friction welding machine with low power, thereby reducing device investment and expanding the use range of the devices.

To further optimize the above technical solution, the auxiliary weld comprises a top auxiliary weld 11 and an excircle auxiliary weld 12. The top auxiliary weld 11 is mainly used for strengthening the connecting quality between the piston head 1 and the piston skirt 2. The excircle auxiliary weld 12 plays the effect of supporting a piston ring.

To further optimize the above technical solution, the top auxiliary weld 11 is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth, thereby enhancing welding quality.

To further optimize the above technical solution, the excircle auxiliary weld 12 is welded by argon arc welding. Because the temperature at an excircle is low, the excircle auxiliary weld 12 only plays the effect of supporting the piston ring. Requirements for the weld are low, and argon arc welding is selected, thereby reducing device investment and reducing the cost.

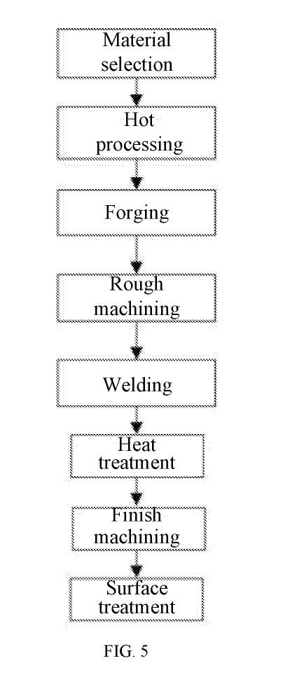

By combing with FIG. 5, the present invention discloses a manufacturing process of a welded integral forged steel piston, comprising the following steps:

S1 material selection: selecting quenched and tempered steel or non-quenched and tempered steel bars with satisfactory diameter according to process requirements, and cutting and preparing the bars with a sawing machine, wherein the quenched and tempered steel is selected from 42CrMo, and the non-quenched and tempered steel is selected from 38MnVS6;

S2 hot processing: determining heating time according to the process requirements, and heating the cut bars with an electromagnetic induction furnace to 1120-1250° C.;

S3 forging: conducting rough forging on the heated bars with a hydraulic press of 400 t; upsetting; removing oxide coatings on the surfaces of the bars; precision forging a piston head blank and a piston skirt blank after rough forging using an electric helical press of 1000 t; and determining precision forging number of times and the size of each precision forging pressure according to the process requirements to obtain the piston head blank and the piston skirt blank;

S4: rough machining: processing the top surface of the cooling oil cavity, the annular inner welding shoulder A and the annular outer welding shoulder A in the piston head blank; processing the bottom surface of the cooling oil cavity, the annular inner welding shoulder B and the annular outer welding shoulder B in the piston skirt blank to obtain a piston head semi-finished product and a piston skirt semi-finished product;

S5 welding: conducting friction welding on the piston head semi-finished product and the piston skirt semi-finished product after precision forging using a friction welding machine; welding the inner welding shoulder A and the inner welding shoulder B with a friction welding machine of 45 t to form a main weld, with the friction welding machine of 45 t having largest upsetting force of 390 KN and largest welding area of 4100 mm²; welding the outer welding shoulder A and the outer welding shoulder B through melting welding to form an auxiliary weld; the auxiliary weld comprising a top auxiliary weld and an excircle auxiliary weld,wherein the top auxiliary weld is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth; and

S6 post processing: conducting heat treatment, finish machining and surface treatment on the welded piston to finally obtain a piston finished product.

To further optimize the above technical solution, in the heat treatment process, the piston forged by the quenched and tempered steel is firstly heated to 845-855° C., insulated for 2-3 hours, taken from a furnace and then oil-cooled; tempering temperature is 590-620° C.; the piston is insulated for 3-4 hours; and finally, the piston is taken from the furnace and air-cooled. The piston forged by the non-quenched and tempered steel is only annealed to remove stress.

To further optimize the above technical solution, in the finish machining: the piston after heat treatment is processed into a ring groove, a pin hole and an excircle profile of the piston; and in the surface treatment, the piston surface after finish machining is phosphorized and graphitized.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A welded integral forged steel piston, comprising a piston head and a piston skirt which are forged, wherein the piston head and the piston skirt are fixedly connected; a closed cooling oil cavity is formed between the piston head and the piston skirt; the cooling oil cavity is communicated with the outside through an oil inlet and an oil outlet, wherein the bottom end of the piston head is concentrically provided with annular inner welding shoulder A and outer welding shoulder A; the top end of the piston skirt is concentrically provided with annular inner welding shoulder B and outer welding shoulder B which are respectively matched with the inner welding shoulder A and the outer welding shoulder A; the inner welding shoulder A and the inner welding shoulder B are welded through friction welding to form a main weld; and the outer welding shoulder A and the outer welding shoulder B are welded through melting welding to form an auxiliary weld.

2. The welded integral forged steel piston of claim 1, wherein the piston head and the piston skirt are forged by quenched and tempered steel or non-quenched and tempered steel; and the quenched and tempered steel is selected from 42CrMo, and the non-quenched and tempered steel is selected from 38MnVS6.

3. The welded integral forged steel piston of claim 2, wherein the oil inlet and the oil outlet are formed in the bottom of the cooling oil cavity on the piston skirt.

4. The welded integral forged steel piston of claim 1, wherein the auxiliary weld comprises a top auxiliary weld and an excircle auxiliary weld.

5. The welded integral forged steel piston according to claim 5, characterized in that the top auxiliary weld is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth.

6. The welded integral forged steel piston of claim 5, wherein the excircle auxiliary weld is welded by argon arc welding.

7. A manufacturing process of a welded integral forged steel piston, comprising the following steps:
S1 material selection: selecting quenched and tempered steel or non-quenched and tempered steel bars with satisfactory diameter according to process requirements, and cutting and preparing the bars with a sawing machine;
S2 hot processing: determining heating time according to the process requirements, and heating the cut bars with an electromagnetic induction furnace to 1120-1250° C.;
S3 forging: conducting rough forging on the heated bars with a hydraulic press of 400 t; upsetting; removing oxide coatings on the surfaces of the bars; precision forging a piston head blank and a piston skirt blank after rough forging using an electric helical press of 1000 t; and determining precision forging number of times and the size of each precision forging pressure according to the process requirements to obtain the piston head blank and the piston skirt blank;
S4: rough machining: processing the top surface of the cooling oil cavity, the annular inner welding shoulder A and the annular outer welding shoulder A in the piston head blank; processing the bottom surface of the cooling oil cavity, the annular inner welding shoulder B and the annular outer welding shoulder B in the piston skirt blank to obtain a piston head semi-finished product and a piston skirt semi-finished product;
S5 welding: conducting friction welding on the piston head semi-finished product and the piston skirt semi-finished product after precision forging using a friction welding machine; welding the inner welding shoulder A and the inner welding shoulder B with a friction welding machine of 45 t to form a main weld, with the friction welding machine of 45 t having largest upsetting force of 390 KN and largest welding area of 4100 mm²; welding the outer welding shoulder A and the outer welding shoulder B through melting welding to form an auxiliary weld; the auxiliary weld comprising a top auxiliary weld and an excircle auxiliary weld, wherein the top auxiliary weld is welded by vacuum electron beam welding; welding speed is 300 mm/min; a welding technology is implemented twice at high voltage of 80 KV; in the first welding technology, preheating is conducted and welding beam current is 15 mA; and in the second welding technology, the welding beam current is determined according to welding depth; and
S6 post processing: conducting heat treatment, finish machining and surface treatment on the welded piston to finally obtain a piston finished product.

8. The manufacturing process of the welded integral forged steel piston of claim 7, wherein in the heat treatment process, the piston forged by the quenched and tempered steel is firstly heated to 845-855° C., insulated for 2-3 hours, taken from a furnace and then oil-cooled; tempering temperature is 590-620° C. ; the piston is insulated for 3-4 hours; finally, the piston is taken from the furnace and air-cooled; and the piston forged by the non-quenched and tempered steel is only annealed to remove stress.

9. The manufacturing process of the welded integral forged steel piston of claim 7, wherein in the finish machining: the piston after heat treatment is processed into a ring groove, a pin hole and an excircle profile of the piston; and in the surface treatment, the piston surface after finish machining is phosphorized and graphitized.
